(19) United States
(12) Patent Application Publication
(10) Pub. No.: US 2019/0335327 A1
(43) Pub. Date: Oct. 31, 2019

(54) PARTITIONING NETWORK ADDRESSES IN NETWORK CELL DATA TO ADDRESS USER PRIVACY

(71) Applicant: T-Mobile USA, Inc., Bellevue, WA (US)

(72) Inventors: Rami Al-Kabra, Bothell, WA (US); Prem Kumar Bodiga, Bellevue, WA (US); Noah Dahlstrom, Seattle, WA (US); Kevin Rivard, Seattle, WA (US)

(21) Appl. No.: 15/965,324

(22) Filed: Apr. 27, 2018

(51) Int. Cl. H04W 12/02; G06F 17/30; G06F 21/62; H04L 29/08; H04W 24/08

(52) U.S. Cl. CPC H04W 12/02; G06F 17/30887; H04W 24/08; H04L 67/02; G06F 21/6254

(57) ABSTRACT

A computing system may automatically anonymize network transaction data of a network transaction by removing a portion of the uniform resource locator (URL) associated with the network transaction. Such anonymization may be beneficial by allowing for the network transaction data to be used (e.g., by third parties) for data analytics, for example, while securing user identities by removing personal information or the identities of individual users engaged in such network transactions. In some examples, network transactions may include phone calls and conversations, video conferencing, text messaging, Internet ac (e.g., file sharing and streaming), and so on.

### BACKGROUND

In recent years, telecommunication devices have advanced from offering simple voice calling services within wireless communication networks to providing users with many new features. Telecommunication devices now provide messaging services such as email, text messaging, and instant messaging. Such devices may also provide data services such as Internet browsing, media services such as storing and playing a library of favorite songs, and location services, just to name a few examples. Thus, telecommunication devices, referred to herein as user devices or mobile devices, are often used in multiple contexts. In addition to such features provided by telecommunication devices, the number of users of these devices have greatly increased. Such an increase in users is expected to continue.

Often, general insights about network users' behavior, and insights about the network itself, may be gained by analyzing data traffic at various scales of the network. For example, information regarding data traffic over individual or multiple network cells may be useful for various data analytics.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 schematically illustrates a wireless communication network, according to various embodiments.

FIG. 2 illustrates a component-level view of an example server configured for use in a wireless communication network.

FIG. 3 schematically illustrates a wireless communication network, according to various embodiments.

FIG. 4 is a schematic diagram of a flow of network transaction data as it evolves to an anonymous state, according to some embodiments.

FIG. 5 is a flow diagram of an example process for anonymizing network transaction data, according to various embodiments.

### DETAILED DESCRIPTION

Described herein are techniques and architectures that allow a computing system to automatically anonymize network transaction data of a network transaction. In various embodiments, such anonymization may be performed by removing a portion of the uniform resource locator (URL) associated with the network transaction. Such anonymization may be beneficial by allowing for the network transaction data to be used (e.g., by third parties) for data analytics, for example, without jeopardizing personal information or the identities of individual users engaged in such network transactions. In some examples, network transactions may include phone calls and conversations, video conferencing, text messaging, Internet accessing and browsing, data uploads and downloads (e.g., file sharing and streaming), and so on.

Often, general insights about network users' behavior, and insights about the network itself, may be gained by analyzing network transaction data at various scales of the network. For example, information regarding network transaction data over individual network cells may be useful for various data analytics. Data analytics may provide useful knowledge for advertisers and network architects and managers, for example. Example embodiments of the disclosure are directed to methods and systems that anonymize data to maintain and/or enhance anonymity of individual users during subsequent operations involving data analytics, such as those performed by third parties.

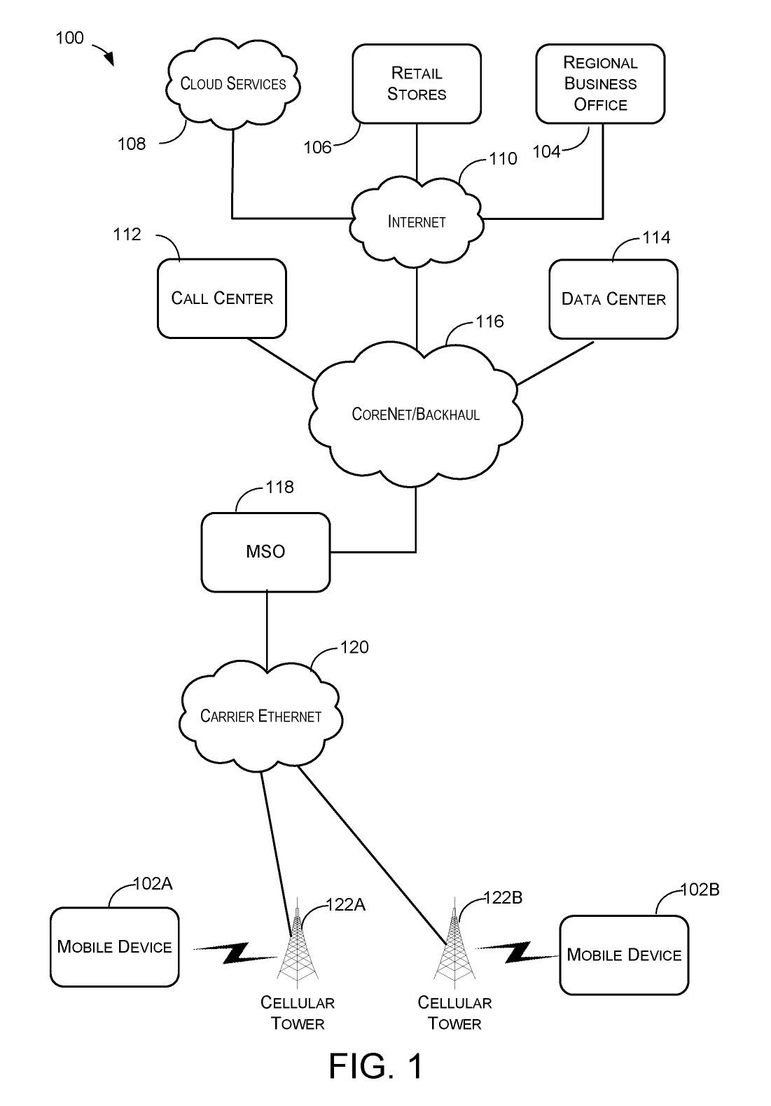

FIG. 1 schematically illustrates an example of a wireless communication network 100 (also referred to herein as network 100) that may be accessed by mobile devices 102A, 102B, referred to hereinafter, individually or collectively, as mobile devices 102. It should also be noted that in example embodiments, the systems and methods as described herein may apply to and/or operate with non-mobile client devices. As can be seen, in various configurations, the wireless communication network 100 includes multiple nodes and networks. The multiple nodes and networks may include one or more of, for example, a regional business office 104, one or more retail stores 106, cloud services 108, the Internet 110, a call center 112, a data center 114, a core net/backhaul network 116, a mobile switch office (MSO) 118, and a carrier Ethernet 120. Wireless communication network 100 may include other nodes and/or networks not specifically mentioned, or may include fewer nodes and/or networks than specifically mentioned. In some examples, network 100 may provide infrastructure for one or more events that occur during an application session.

Access points such as, for example, cellular towers 122A, 122B, can be utilized to provide access to wireless communication network 100 for mobile devices 102. In various configurations, wireless communication network 100 may represent a regional or subnetwork of an overall larger wireless communication network. Thus, a larger wireless communication network may be made up of multiple networks similar to wireless communication network 100 and thus the nodes and networks illustrated in FIG. 1 may be replicated within the larger wireless communication network. In particular, in the example situation illustrated in FIG. 1, mobile device 102A is in a cell serviced by cellular tower 122A and mobile device 102B is in a cell serviced by cellular tower 122B.

In various configurations, mobile devices 102 may comprise any devices for communicating over a wireless communication network. Such devices include mobile telephones, cellular telephones, mobile computers, Personal Digital Assistants (PDAs), radio frequency devices, handheld computers, laptop computers, tablet computers, palmtops, pagers, as well as desktop computers, devices configured as Internet of Things (IoT) devices, integrated devices combining one or more of the preceding devices, and/or the like. As such, mobile devices 102 may range widely in terms of capabilities and features. For example, one of mobile devices 102 may have a numeric keypad, a capability to display only a few lines of text and be configured to interoperate with only GSM networks. However, another of mobile devices 102 (e.g., a smart phone) may have a touch-sensitive screen, a stylus, an embedded GPS receiver, and a relatively high-resolution display, and be configured to interoperate with multiple types of networks. The mobile devices may also include SIM-less devices (i.e., mobile devices that do not contain a functional subscriber identity module (“SIM”)), roaming mobile devices (i.e., mobile devices operating outside of their home access networks), and/or mobile software applications.

In configurations, wireless communication network 100 may be configured as one of many types of networks and thus may communicate with mobile devices 102 using one or more standards, including but not limited to GSM, Time Division Multiple Access (TDMA), Universal Mobile Telecommunications System (UMTS), Evolution-Data Optimized (EVDO), Long Term Evolution (LTE), Generic Access Network (GAN), Unlicensed Mobile Access (UMA), Code Division Multiple Access (CDMA) protocols (including IS-95, IS-2000, and IS-856 protocols), Advanced LTE or LTE+, Orthogonal Frequency Division Multiple Access (OFDM), General Packet Radio Service (GPRS), Enhanced Data GSM Environment (EDGE), Advanced Mobile Phone System (AMPS), WiMAX protocols (including IEEE 802.16e-2005 and IEEE 802.16m protocols), High Speed Packet Access (HSPA), (including High Speed Downlink Packet Access (HSDPA) and High Speed Uplink Packet Access (HSUPA)), Ultra Mobile Broadband (UMB), and/or the like. In embodiments, as previously noted, the wireless communication network 100 may include an IMS 100a and thus, may provide various services such as, for example, voice over long term evolution (VoLTE) service, video over long term evolution (ViLTE) service, rich communication services (RCS) and/or web real time communication (Web RTC).

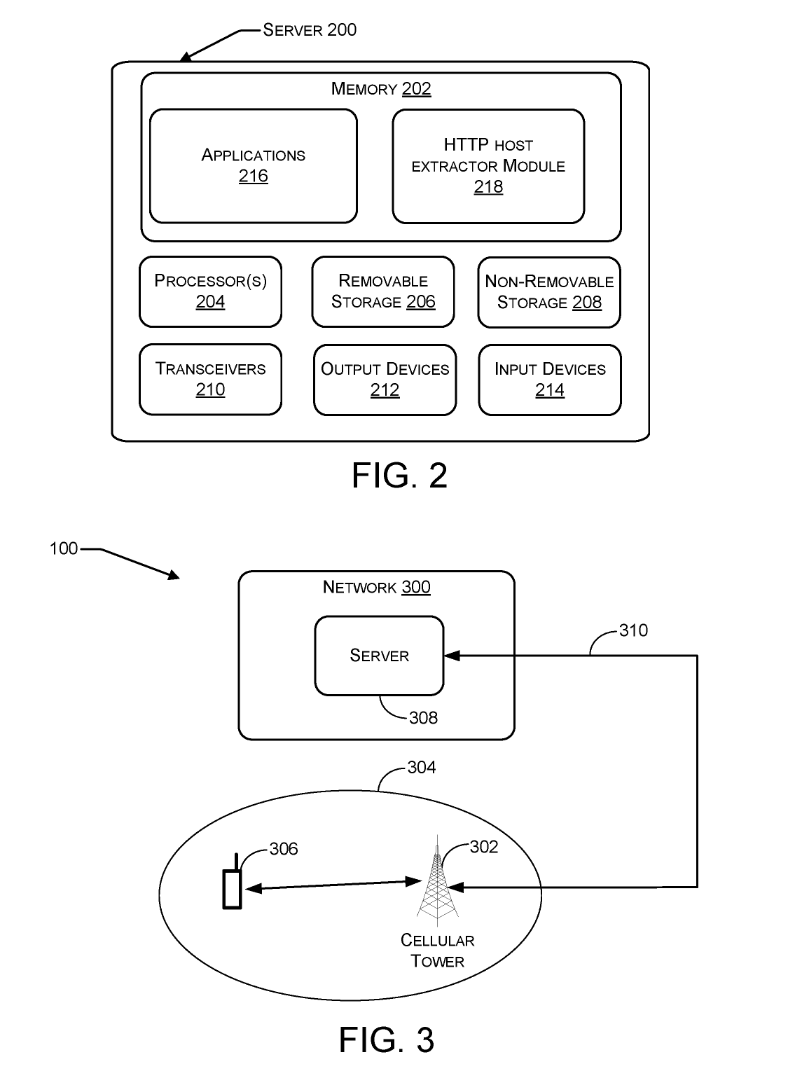

FIG. 2 schematically illustrates a component-level view of a server 200. Server 200 may be configured as a node for use within a wireless communication network such as 100, according to processes described herein. In some embodiments, server 200 may be a baseband unit (BBU). Server 200 includes a system memory 202, processor(s) 204, a removable storage 206, a non-removable storage 208, transceivers 210, output device(s) 212, and input device(s) 214.

In various implementations, system memory 202 is volatile (e.g., RAM), non-volatile (e.g., ROM, flash memory, etc.) or some combination of the two. In some implementations, processor(s) 204 is a central processing unit (CPU), a graphics processing unit (GPU), or both CPU and GPU, or any other sort of processing unit. System memory 202 may also include applications 216 that allow the server to perform various functions. Among applications 216 or separately, memory 202 may also include an HTTP host extractor module 218, which is described in detail below.

In some embodiments, server 200 may be a computing system configured to automatically anonymize network transaction data of a network transaction. Accordingly, applications 216 may include code that, upon execution, allows server 200 to gather network transaction data of a network transaction performed by a client device (e.g., 102) in a wireless communication network (e.g., 100), wherein the network transaction involves a website that has an associated URL and the network transaction data includes the URL; partition the URL into a hypertext transfer protocol (HTTP) host URL portion and a remaining URL portion; and to remove the remaining URL portion from the network transaction data to produce partially anonymous network transaction data that includes the http host URL portion with the network transaction data. By stripping the remaining URL portion, and leaving the HTTP host URL portion of the overall URL, useful information about network transaction data may be collected, while obfuscating identities of individual users.

Server 200 may also include additional data storage devices (removable and/or non-removable) such as, for example, magnetic disks, optical disks, or tape. Such additional storage is represented in FIG. 2 by removable storage 206 and non-removable storage 208.

Non-transitory computer-readable media may include volatile and nonvolatile, removable and non-removable tangible, physical media implemented in technology for storage of information, such as computer readable instructions, data structures, program modules, or other data. System memory 202, removable storage 206 and non-removable storage 208 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by server 200. Any such non-transitory computer-readable media may be part of server 200.

In some implementations, transceivers 210 include any sort of transceivers known in the art. For example, transceivers 210 may include wired communication components, such as an Ethernet port, for communicating with other networked devices. Also or instead, transceivers 210 may include wireless modem(s) to may facilitate wireless connectivity with other computing devices. Further, transceivers 210 may include a radio transceiver that performs the function of transmitting and receiving radio frequency communications via an antenna.

In some implementations, output devices 212 include any sort of output devices known in the art, such as a display (e.g., a liquid crystal display), speakers, a vibrating mechanism, or a tactile feedback mechanism. Output devices 212 also include ports for one or more peripheral devices, such as headphones, peripheral speakers, or a peripheral display.

In various implementations, input devices 214 include any sort of input devices known in the art. For example, input devices 214 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

FIG. 3 schematically illustrates a wireless communication network 300, according to various embodiments. In particular, network 300, which may be a subset of wireless communication network 100, includes a cellular tower 302 that establishes a network cell 304. A wireless device 306 is located within network cell 304. Cellular tower 302 and wireless device 306 are wirelessly connected for two-way communication. Network 300 includes a server 308, which may be similar to or the same as server 200, that receives and transmits signals via wired or wireless path 310. Server 308 may, for example, be located in core net/backhaul network 116 or MSO 118 of network 100.

Any number of wireless devices 306 may communicate with cellular tower 302. For example, though FIG. 3 merely illustrates one wireless device 306, multiple wireless devices may communicate with cellular tower 302 at the same time or at different times. This communication includes network transactions such as phone calls and conversations, video conferencing, text messaging, Internet accessing and browsing, data uploads and downloads (e.g., file sharing and streaming), and so on.

In various embodiments, server 308 may gather network transaction data of a network transaction performed by wireless device 306 in network 100. Such network transaction data may include metadata (e.g., data quantity, timing, direction, identity of user and type of wireless device, and so on) of phone calls and conversations, video conferencing, text messaging, Internet accessing and browsing, and data uploads and downloads (e.g., file sharing and streaming), just to name a few examples. Server 308 may partition the URL associated with the network transaction into an HTTP host URL portion and a remaining URL portion. Server 308 may subsequently remove the remaining URL portion from the network transaction data to produce partially anonymous network transaction data that includes the HTTP host URL portion with the network transaction data. Such partial anonymity results from removal of the portion of the URL that generally includes details of the network transaction indicated by parameters of the URL. Thus, information about a user's personal and/or private data may be removed from the network transaction data. As a result, data analytics techniques (e.g., by pattern analysis or machine learning) may be prevented from determining any particular user's browsing patterns and habits, or indeed any information which also may be considered to be personal to the user.

The network transaction data, may further include various information about phone calls and conversations, video conferencing, text messaging, Internet accessing and browsing, data uploads and downloads (e.g., file sharing and streaming), and so on. This information may be anonymized by removing the network transaction data from the partially anonymous network transaction data except for the HTTP host URL portion. In other words, the remaining HTTP host URL portion comprises anonymous information that may be useful for subsequent data analytics while maintaining anonymity for the user(s).

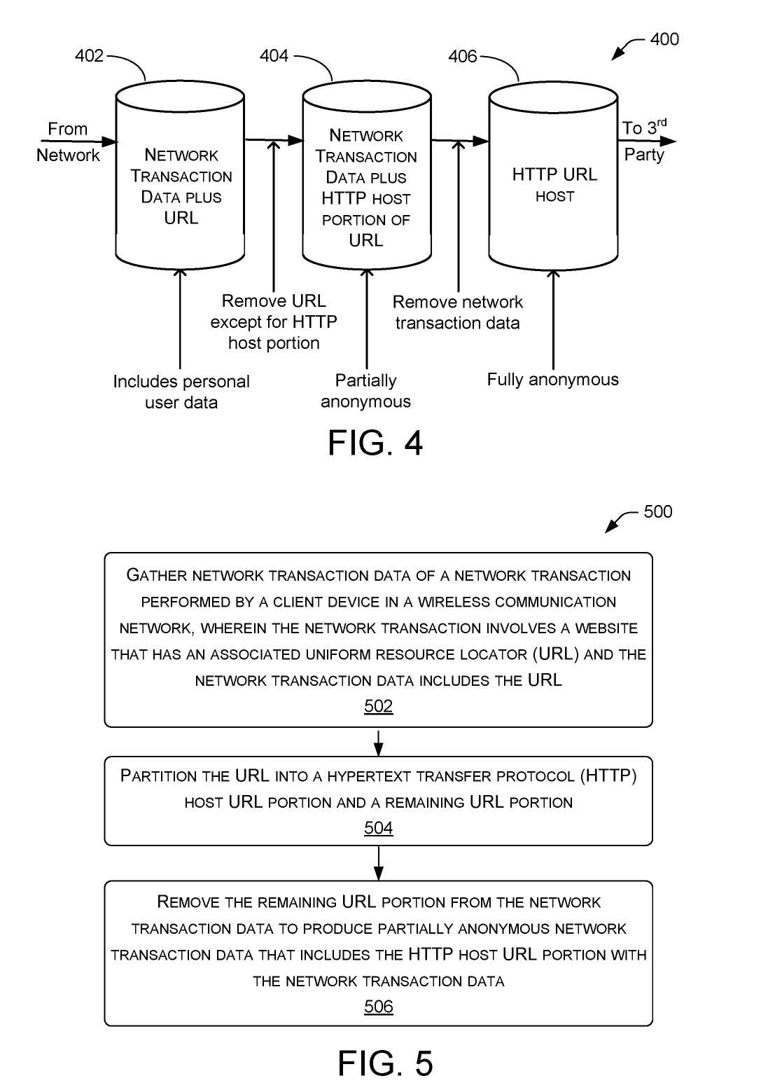

FIG. 4 is a schematic diagram of a flow 400 of network transaction data as it evolves to an anonymous state, according to some embodiments. For example, data flow 400 may begin by server 308 receiving network transaction data from any portion of network 100 and placing such data in a database 402 that stores the network transaction data. Generally, this data includes personal user data in the form of detailed URL addresses that can be anonymized according to the operations as disclosed herein. The anonymization of this data may obfuscate user identity and may prevent the data from being used to determine (e.g., by pattern analysis or machine learning) any individual user's browsing patterns and habits. In this way, information that may be considered to be personal to a user may be secured and may not be traced back to the user.

Data flow 400 may continue with a process, which may be performed by HTTP host extractor module 218 that removes a portion of the URLs of websites visited by the user. The portion of the URL remaining and stored with the network transaction data in a database 404 is the HTTP host portion. Such removal of all but the HTTP host portion of the URL leads to at least a partial anonymity of the network transaction data. A second anonymization process may be performed to obfuscate and/or remove various information about phone calls and conversations, video conferencing, text messaging, Internet accessing and browsing, data uploads and downloads, and so on, to fully anonymize the data in database 404. Thus information that has the potential to be used to identify (e.g., by pattern analysis or machine learning) the user and determine at least some of the user's private details is further stripped from, and no longer available to, an entity that may use the data for various analytics. This more complete anonymity operation may be accomplished by removing the network transaction data from the partially anonymous network transaction data of database 404. Performing this process leads to storing the remaining HTTP host portion of the URL in a database 406, which comprises anonymous information that may be useful for subsequent data analytics while maintaining anonymity for the user(s) to whom the information pertains. The data in database 406 may, in some examples, be provided to third parties to perform such analytics.

FIG. 5 is a flow diagram of an example process for anonymizing network transaction data, according to various embodiments. For example, process 500 may be performed by server 308, illustrated in FIG. 3, or more specifically, in other examples, may be performed by a combination of applications module 216 and HTTP host extractor module 218, illustrated in FIG. 2. At block 502, the server may gather network transaction data of a network transaction performed by a client device in a wireless communication network 100. Here, the network transaction involves a website that has a URL and thus the network transaction data includes the URL. In some examples, the network transaction data includes type, direction, quantity, and time of data flow of the network transaction. In various examples, the network transaction is non-encrypted. In other examples, which involve encryption, the HTTP host of the URL comprises an HTTP secure (HTTPS) host of the URL.

At block 504, the server may partition the URL into an HTTP host URL portion and a remaining URL portion, which does not include the host portion. In some embodiments, partitioning the URL into the HTTP host URL portion and the remaining URL portion comprises scanning the URL to identify individual characters, identifying a predetermined character among multiple characters of the URL, and dividing the URL at the predetermined character to partition the URL into the HTTP host URL portion and the remaining URL portion. For example, the predetermined character may be the question mark “?”. In some general implementations, “?” is used as an identifier in the URL to separate the HTTP host from the remaining portions of the URL, which may indicate a query or path of the URL.

At block 506, the server may remove the remaining URL portion from the network transaction data to produce at least partially anonymous network transaction data that includes the HTTP host URL portion with the network transaction data. In some embodiments the server may remove the network transaction data from the remaining URL portion to produce anonymous network transaction data that, among the URL and the network transaction data, includes only the HTTP host URL portion. The server may subsequently aggregate the anonymous network transaction data with additional anonymous network transaction data associated with additional network transactions performed by the client device or other client devices in the wireless communication network. One of ordinary skill in the art will recognize that the process 500 may be performed in any number of appropriate ways, including but not limited to these examples.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A computer-implemented method comprising:
gathering network transaction data of a network transaction performed by a client device in a wireless communication network, wherein the network transaction involves a website that has an associated uniform resource locator (URL) and the network transaction data includes the URL;
partitioning the URL into a hypertext transfer protocol (http) host URL portion and a remaining URL portion; and
removing the remaining URL portion from the network transaction data to produce partially anonymous network transaction data that includes the http host URL portion with the network transaction data.

2. The computer-implemented method of claim 1, further comprising:
removing the network transaction data from the partially anonymous network transaction data to produce anonymous network transaction data that, among the URL and the network transaction data, includes only the http host URL portion.

3. The computer-implemented method of claim 2, further comprising:
aggregating the anonymous network transaction data with additional anonymous network transaction data associated with additional network transactions performed by the client device or other client devices in the wireless communication network.

4. The computer-implemented method of claim 1, wherein partitioning the URL into the http host URL portion and the remaining URL portion comprises:
scanning the URL;
identifying a predetermined character among multiple characters of the URL; and
dividing the URL at the predetermined character to partition the URL into the http host URL portion and the remaining URL portion.

5. The computer-implemented method of claim 1, wherein the network transaction data includes type, direction, quantity, and time of data flow of the network transaction.

6. The computer-implemented method of claim 1, wherein the network transaction is non-encrypted.

7. The computer-implemented method of claim 1, wherein the http host URL portion comprises an http secure (https) URL portion.

8. An apparatus comprising:
a non-transitory storage medium; and
instructions stored in the non-transitory storage medium, the instructions being executable by the apparatus to:
gather network transaction data of a network transaction performed by a client device in a wireless communication network, wherein the network transaction involves a website that has an associated uniform resource locator (URL) and the network transaction data includes the URL;
partition the URL into a hypertext transfer protocol (http) host URL portion and a remaining URL portion; and
remove the remaining URL portion from the network transaction data to produce partially anonymous network transaction data that includes the http host URL portion with the network transaction data.

9. The apparatus of claim 8, the instructions further being executable by the apparatus to:
remove the network transaction data from the partially anonymous network transaction data to produce anonymous network transaction data that, among the URL and the network transaction data, includes only the http host URL portion.

10. The apparatus of claim 9, the instructions further being executable by the apparatus to:
aggregate the anonymous network transaction data with additional anonymous network transaction data associated with additional network transactions performed by the client device or other client devices in the wireless communication network.

11. The apparatus of claim 8, wherein partitioning the URL into the http host URL portion and the remaining URL portion comprises:
scanning the URL;
identifying a predetermined character among multiple characters of the URL; and
dividing the URL at the predetermined character to partition the URL into the http host URL portion and the remaining URL portion.

12. The apparatus of claim 8, wherein the network transaction data includes type, direction, quantity, and time of data flow of the network transaction.

13. The apparatus of claim 8, wherein the network transaction is non-encrypted.

14. The apparatus of claim 8, wherein the http host URL portion comprises an http secure (https) URL portion.

15. A wireless communication network comprising:
one or more processors;
a non-transitory storage medium; and
instructions stored in the non-transitory storage medium, the instructions being executable by the one or more processors to:
gather network transaction data of a network transaction performed by a client device in a wireless communication network, wherein the network transaction involves a website that has an associated uniform resource locator (URL) and the network transaction data includes the URL;
partition the URL into a hypertext transfer protocol (http) host URL portion and a remaining URL portion; and
remove the remaining URL portion from the network transaction data to produce partially anonymous network transaction data that includes the http host URL portion with the network transaction data.

16. The wireless communication network of claim 15, the instructions further being executable by the one or more processors to:
remove the network transaction data from the partially anonymous network transaction data to produce anonymous network transaction data that, among the URL and the network transaction data, includes only the http host URL portion.

17. The wireless communication network of claim 16, the instructions further being executable by the one or more processors to:
aggregate the anonymous network transaction data with additional anonymous network transaction data associated with additional network transactions performed by the client device or other client devices in the wireless communication network.

18. The wireless communication network of claim 15, wherein partitioning the URL into the http host URL portion and the remaining URL portion comprises:
scanning the URL;
identifying a predetermined character among multiple characters of the URL; and
dividing the URL at the predetermined character to partition the URL into the http host URL portion and the remaining URL portion.

19. The wireless communication network of claim 15, wherein the network transaction is non-encrypted.

20. The wireless communication network of claim 15, wherein the http host URL portion comprises an http secure (https) URL portion.
